(19) United States
(12) Patent Application Publication
(10) Pub. No.: US 2009/0053759 A1
(43) Pub. Date: Feb. 26, 2009

(54) METHOD AND DEVICE FOR PREPARING BIOLOGICAL SAMPLES

(75) Inventors: Bjoern Quast, Berlin (DE); Alexander Gruhl, Berlin (DE)

Correspondence Address: Workman Nydegger;1000 Eagle Gate Tower, 60 East South Temple, Salt Lake City, UT, 84111, US

(73) Assignee: FREIE UNIVERSITAT BERLIN, Berlin (DE)

(21) Appl. No.: 12/278,925

(22) PCT Filed: Feb. 9, 2007
(86) PCT No.: PCT/DE07/00299

§ 371 Date: Oct. 13, 2008

(30) Foreign Application Priority Data
Feb. 10, 2006 (DE) 10 2006 006 899.8

(51) Int. Cl. G01N 1/30; G01N 1/31

(52) U.S. Cl. 435/40.52; 435/309.1

(57) ABSTRACT

A method for preparing biological samples by means of a series of different liquids containing preparation agents in a chamber is provided. The chamber comprises a first and a second opening for supplying and removing liquid to and from the chamber. The chamber is brought into a first position, in which the first opening is located above the second opening when the liquid to be introduced into the chamber has a lower density than the liquid in the chamber. The chamber is brought into a second position, in which the first opening is located below the second opening when the liquid to be introduced into the chamber has a higher density than the liquid in the chamber.

### CROSS-REFERENCE TO A RELATED APPLICATION

This application is a National Phase Patent Application of International Patent Application Number PCT/DE2007/000299, filed on Feb. 9, 2007, which claims priority of German Patent Application Number 10 2006 006 899.8, filed on Feb. 10, 2006.

### BACKGROUND

The invention relates to a method and a device for preparing biological samples by means of a series of different liquids containing preparation agents. By such a method it is possible for example to mark the samples by staining.

For a number of methods of examining biological samples, for example the examination of sections of biological tissue by transmission electron microscopy, it is necessary to prepare the samples by marking them by staining. The staining is performed by treatment with preparation agents such as heavy-metal solutions. In electron microscopy, uranyl acetate and lead citrate solutions are generally used for this. The dissolved heavy metals attach themselves to specific cell structures and thereby increase the contrast in the electron-microscopic image. For the treatment of tissue sections, various methods have so far been used, ranging from manual contrasting to automated methods.

Manual contrasting methods are carried out with the aid of drops of the marking solution in petri dishes. Considerable effort is necessary for this in terms of manual activity, in particular if large series of tissue samples are to be marked. Furthermore, there is the risk of impairment being caused by contaminants that can enter the samples and the marking solutions during the manual work.

These manual contrasting methods have a number of disadvantages. Uranyl acetate and lead citrate are highly toxic. When lead citrate solutions come into contact with CO₂, lead carbonate is precipitated. Furthermore, the tissue sections may be rendered unusable by contaminants during the treatment. Therefore, manual contrasting entails very great problems. Furthermore, only a small number of grids (i.e. small object carriers for electron-microscopic preparations) can be treated simultaneously. Although there are manual methods by which a relatively great amount of grids can be treated in simple holding devices, these do not solve the problem of precipitation and contamination.

In the case of a method and a device of the type mentioned at the beginning, it is known from U.S. Pat. No. 4,358,470 to provide a fixed chamber comprising a first, upper connection and a second, lower connection, which are connected to liquid containers by means of a valve system. The valve system controls the supply and removal of the liquids to and from the chamber in such a way that the liquid is introduced into the chamber via the first, upper connection when the liquid to be introduced has a lower density than the liquid in the chamber, and the liquid is introduced into the chamber via the second, lower connection when the liquid to be introduced has a higher density than the liquid in the chamber. This is intended to avoid mixing of the liquids.

The company Leica Microsysteme GmbH sells a unit for the automatic contrasting of up to 25 grids in one operation under the designation “EMSTAIN”. In the case of this unit, the grids are positioned in a fixed chamber which has a line connection respectively on the upper side and on the underside. The solutions necessary for a contrasting operation are pumped into the chamber one after the other by means of a system of lines and valves. In order not to mix heavy and light solutions unnecessarily, the liquid stream must be reversed a number of times during the contrasting process by means of valve switching.

In the case of U.S. Pat. No. 4,358,470 and in the case of the unit from the company Leica Microsysteme GmbH, complex valve switching is required to change the direction of the liquid stream. This leads to a high consumption of liquids. Furthermore, complex cleaning routines are necessary.

### SUMMARY

The invention is based on the object of simplifying the changing of the liquids to be introduced into the chamber in the case of a method or a device of the type mentioned at the beginning.

The invention is based in particular on the object of reducing the line paths that the liquids to be introduced into the chamber have to flow through and their dead spaces in the case of a method or device of the type mentioned at the beginning.

The invention is also based on the object of simplifying the cleaning in the case of a method or device of the type mentioned at the beginning.

For supplying and removing the liquids that are used for preparing biological samples into and from a chamber, the device has a means which comprises at least one supply line, at least one removal line, at least one liquid reservoir or container and preferably at least one valve, which is assigned in particular to a liquid reservoir and regulates the supplying of the liquid from this liquid reservoir into the supply line connected to the liquid reservoir. A further valve or a number of further valves may divide up the waste flow among various waste lines and waste containers, in order to make it possible for the different liquids that are used to be collected separately after their use.

A series of different liquids containing preparation agents is understood as meaning successively introducing different liquids into the chamber or sequentially bringing the (biological) samples to be prepared into contact with different liquids. In this case, the method according to the invention and the device according to the invention are designed in such a way that not only liquids containing preparation agents but also flushing liquids, such as water in particular, can be used.

As in the case of U.S. Pat. No. 4,358,470 and the mentioned unit from the company Leica Microsysteme GmbH, to avoid mixing of the liquids, the liquid is introduced into the chamber from the top when the liquid to be introduced has a lower density than the liquid in the chamber and is introduced into the chamber from the bottom when the liquid to be introduced has a higher density than the liquid in the chamber.

By contrast with U.S. Pat. No. 4,358,470 and the mentioned unit from the company Leica Microsysteme GmbH, however, according to the invention the direction of the liquid stream is not changed by valve switching if the chamber is to be filled from the top or from the bottom. In the case of the method according to the invention and the device according to the invention, the liquids are always supplied to the chamber via one and the same chamber opening and are always removed from the chamber via one and the same chamber opening.

The optional filling of the chamber from above or from below is achieved by it being possible for the chamber to be brought into two different positions. Depending on the position, the inlet opening is then located above or below the outlet opening.

In this case, the supply line, which is connected to a first opening in the chamber, and the removal line, which is connected to a second opening in the chamber, are moved. That is to say, if the first opening is arranged above the second opening, the supply line (at least in the contact region with the first opening) is also arranged above the removal line. A separation between the supply line and the first opening connected to it or between the removal line and the second opening connected to it does not take place during the preparation of the sample.

The possibility of turning the chamber therefore allows the inlet opening and the outlet opening to be respectively brought into the correct position. This obviates the need for a complicated valve system, which would otherwise have to regulate the inflow and outflow of the chamber and regularly bring about a reversal of the direction of flow in the chamber.

The possibility of bringing the chamber into different positions, so that a change in direction of the liquid stream is not required, allows a considerable shortening of the line paths that are used in the system to be achieved. A system with directional reversal always requires additional valves, which by the nature of their structural design always have a certain dead space. The directional reversal requires alternative lines either on the chamber or in the valve region for the supply and outflow of the marking solutions at the respective chamber opening. If, however, the direction of the liquid stream is not reversed, only one line is necessary for the inlet opening and the outlet opening.

The lines via which the heavy-metal solutions are conducted to the chamber must always be additionally flushed, since lead citrate must not meet neuronal acetate (precipitate). In the case of a system with directional reversal, solutions of greater density are supplied and removed through the lines connected to the chamber at the bottom, solutions of lower density are supplied and removed through the lines connected to the chamber at the top. In order that incompatible heavy solutions are not pumped directly one after the other through the lower lines, the remains of marking solutions that are left in the lines must be additionally flushed out.

In the case of the system according to the present invention, all the liquids are delivered via the same line, in the sequence in which they are to enter the chamber. Remains of the marking solutions are consequently automatically flushed out of the line with the next solution intended for the marking (and consequently compatible).

The short line paths of the system according to the present invention make the time spent on routine cleaning considerably less than in the case of corresponding units according to the prior art. The line system does not require alternative line paths for the directional reversal. The cleaning solutions can be pumped through the system in one and the same direction as the marking solutions and thereby reach the entire line system supplying to and removing from the chamber.

In the case of a system with directional reversal, on the other hand, the cleaning solutions must be flushed successively through the alternative line paths.

Dispensing with directional reversal also minimizes the number of valves necessary in the device, and the consequently necessarily associated dead spaces.

Furthermore, in the case of the mentioned unit from the company Leica Microsystems GmbH, sensitive components of the valves and the pump are in direct contact with the liquids. These components are produced from materials that are not adequately resistant to aggressive media such as occur here. As a result, on the one hand deposits and on the other hand the low pH of the solutions used can lead to damage and malfunctions. It is therefore not possible with this unit to achieve consistent quality of the contrasting operations over relatively long periods of time.

To avoid such damage and malfunctions, in the case of the device according to the invention the pumps and/or valves include a hollow body of a flexible material that is resistant to the aggressive media used, preferably a hose, the liquids flowing through the pumps and/or valves coming into contact exclusively with this hollow body while they flow through the pumps and/or valves. As a result, the liquids do not come into contact with sensitive components of the pumps or valves. Accordingly, the pumps and/or valves preferably comprise peristaltic hose pumps and solenoid pinch valves.

The hoses used are exemplary then chosen in accordance with the chemical properties of the solutions used. Furthermore, the hoses can be replaced very much more easily and inexpensively in the event of damage than other mechanical components of pumps and valves. It goes without saying that such pumps and/or valves provided with hollow bodies that are resistant to aggressive media can be used not only in the case of the device according to the invention but also in the case of any unit according to the prior art in which aggressive media flow through the pumps and/or valves, in particular in the case of devices for preparing biological samples by means of a series of different liquids containing preparation agents according to the precharacterizing clause of claim 8.

The chemical nature of the solutions used and the high standard of purity, for example for electron-microscopic preparations, impose the following requirements on a contrasting unit, which can be met by the method according to an exemplary embodiment of the invention and the device according to an exemplary embodiment of the invention:

(1) The device should be of such a nature that air contact (in particular of the lead citrate with CO₂) is prevented.
(2) The line system as well as the valves and the pump should be as insensitive as possible to the aggressive substances of the liquids and possible deposits.
(3) The system should allow itself to be rinsed well with nitric acid (HNO₃), which dissolves deposits. This is assisted by short line paths and smallest possible dead spaces. Furthermore, the consumption of (toxic) chemicals is reduced in this way.
(4) All the constituents of the line system should be easily and inexpensively exchangeable.

The first opening of the device according to the invention is exemplary connected to a supply line system which has at least one liquid reservoir and at least one valve, in order to make it possible for the liquid required for preparing or flushing the specimen to be supplied to the chamber. In particular, it is advantageous if more than one liquid reservoir is provided, to make it possible in a simple way to introduce a series of different liquids into the chamber.

In a exemplary configuration of the invention, the chamber has a third opening, which is arranged adjacent the first opening, that is to say in particular in the direct vicinity thereof, in such a way that the geometrical alignment of the third opening with respect to the second opening in the chamber is substantially equal to the geometrical alignment of the first opening with respect to the second opening in the chamber.

The third opening of the chamber is exemplary connected to a supply line system that is constructed in a substantially equivalent manner to the supply line system with which the first opening is connected in a preferred configuration of the invention. The number of liquid reservoirs used may, however, vary between the supply line system connected to the first opening and the supply line system connected to the third opening.

In an alternative exemplary configuration of the invention, the third opening is formed in such a way that it can receive a manually operable filling device. For this purpose, an adapter which serves to enable the filling device to be received in the third opening may also be attached to the third opening or integrated in the third opening. A manually operable filling device for the purposes of the present invention is, for example, a customary one-way syringe or a Hamilton syringe or a comparable device for metering fluids.

The device is exemplary configured in such a way that integrated in the supply line system is a mixing device, into which the various liquids to be used are introduced in a specific, predeterminable mixing ratio. After mixing of the liquids introduced, they can then be supplied to the chamber and the sample arranged therein. This variant of the invention can only be meaningfully used when the liquids to be mixed do not undergo any incompatibility reactions with one another (such as for example the precipitating of a precipitate or the like).

### BRIEF DESCRIPTION OF THE DRAWINGS

An exemplary embodiment of the invention is explained in more detail below with reference to the figures, in particular FIG. 1, in which:

FIG. 1 shows a schematic representation of a first exemplary embodiment of the invention in a first operating state.

FIG. 2 shows a schematic representation of the first exemplary embodiment of the invention in a second operating state.

FIG. 3 shows a schematic representation of a second exemplary embodiment of the invention.

FIG. 4 shows a schematic representation of a third exemplary embodiment of the invention.

### DETAILED DESCRIPTION

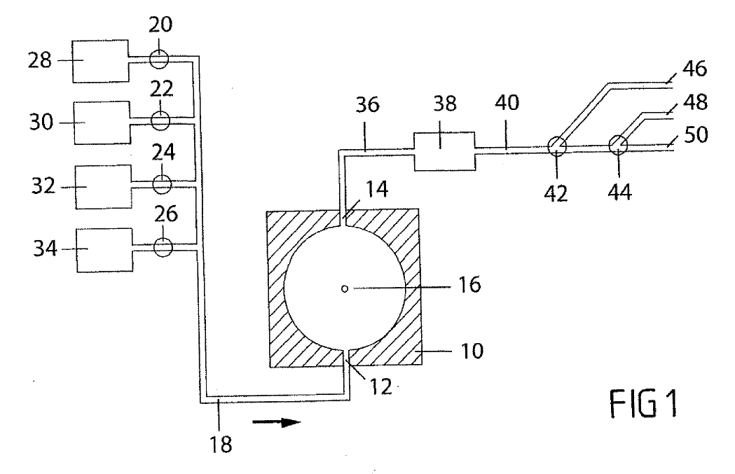

In FIG. 1, a chamber is designated by 10. The chamber 10 has an inlet opening 12 and an outlet opening 14. The chamber 10 is rotatably mounted on a carrier (not represented in figure) about an axis 16, so that the chamber 10 can be brought into different positions.

The rotation of the chamber 10 takes place by means of an electric motor (not represented in the figure). The chamber 10 can be arrested in two positions, offset by an angle of 180°.

In the position of the chamber 10 that is represented in FIG. 1, the inlet opening 12 is located below the outlet opening 14. In this case, the outlet opening 14 is located vertically above the inlet opening 12. This corresponds to the second position of the chamber 10 according to the invention, which corresponds to a first operating state of the device. The face of the chamber 10 that is facing upward on the paper in FIG. 1 (in which the outlet opening 14 is arranged) is also actually aligned upward in the device according to the invention, while the face of the chamber 10 that is facing downward in FIG. 1 (in which the inlet opening 12 is arranged) is aligned downward in the device according to the invention.

In the exemplary embodiment represented, the chamber comprises two parts, to be specific a base plate and a top plate. The base plate is square, with a side length of approximately 5 cm and a height of 5 mm. It serves as a rest for the grid plate. The top plate has the same side lengths and has a height of 10 mm. The top plate has a 4 mm deep circular recess with a diameter of 38 mm. This recess forms the hollow space in which the grids are bathed by the solutions. Leading into the recess are two bores of about 1 mm (openings 12 and 14), which in the assembled chamber lie at the respectively lowest and highest points of the recess. The two parts of the chamber are held together with the grid plate arranged in between by a receiving device (not represented), which is connected directly to the electric motor.

The inlet opening 12 and the outlet opening 14 do not necessarily have to run to the circular circumference of the cylindrical hollow space of the chamber 10 from the bottom and the top, respectively, as represented in FIG. 1, but may also run perpendicularly in relation to the circular circumference of the hollow space, that is to say perpendicularly to the cover face of the cylindrical hollow space that is facing the front in FIG. 1, and establish a corresponding connection of the hollow space of the chamber 10 to the system of supply lines or removal lines of the hoses 18, 36. In this case, the inlet opening 12 and the outlet opening 14 would be arranged at the substantially highest and substantially lowest points of the recess or the hollow space of the chamber 10 in the assembled state of the chamber 10, which are also to be understood as the highest or lowest point of the chamber 10 for the purposes of the invention.

The chamber 10 does not necessarily have to have a cylindrical shape, but may have any desired shape. Possibilities of great variation are also conceivable with respect to the volume of the chamber 10 or its hollow space. A volume of around 3.5 ml has proven to be favorable for a treatment of grids. For other application purposes, much greater or much smaller volumes may be of advantage.

The inlet opening 12 of the chamber 10 can be connected to liquid containers via the hose or the hoses 18 and electromagnetic solenoid pinch valves. In the exemplary embodiment represented, four such solenoid pinch valves 20, 22, 24 and 26 and four such liquid containers 28, 30, 32 and 34 are provided. The inflow of the necessary liquids from the liquid containers 28, 30, 32 and 34 to the chamber 10 is regulated by means of the electromagnetic solenoid pinch valves 20, 22, 24 and 26.

The exemplary embodiment represented is a contraster, by which thin tissue sections are to be treated with heavy-metal solutions. Accordingly, the liquid container 28 contains water, the liquid container 30 contains nitric acid, the liquid container 32 contains uranyl acetate and the liquid container 34 contains lead citrate. The chamber 10 serves for receiving a grid plate loaded with grids (the company Hiraoka, sold through Electronmicroscopy Sciences under the article number 71560-10). This consists of a flexible plastic and has slots for receiving the grids. These slots can be opened by bending the plate and loaded with grids. The grids are arrested when the plate relaxes.

The outlet opening 14 of the chamber 10 is connected to a peristaltic hose pump 38 via a hose 36. The peristaltic hose pump 38 is connected furthermore to two 3-way solenoid pinch valves 42 and 44 via a hose 40. Downstream of the 3-way solenoid pinch valves 42 and 44, hoses 46, 48 and 50 lead to waste containers (not represented in the figure). (In the case of the unit described above from the company Leica Microsysteme GmbH, the waste is likewise sorted, but not by 3-way solenoid pinch valves).

The peristaltic hose pump used here is a model SR 25 from the company Rietschle Thomas Puchheim GmbH, Siemensstr. 4, 82178 Puchheim, and the solenoid pinch valves used here are the models S104.09 and S305.07 from the company Sirai Deutschland GmbH, Mutnchener Straβe 15, 85643 Steinhoring.

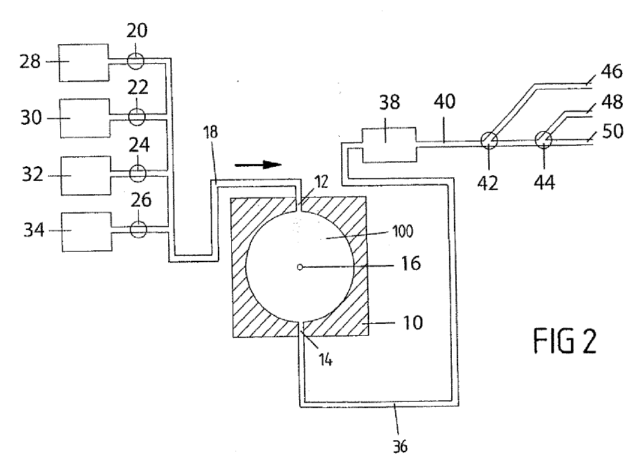

The device carries out the contrasting method by the following steps:
1. Wetting: The valve 20 is opened and H₂O is sucked from the container 28 through the pump 38 into the chamber 10, until the latter is completely filled. The H₂O remains in the chamber for about 5 minutes.
2. Contrasting with uranyl acetate: The valve 24 is opened and uranyl acetate is sucked from the container 32 into the chamber 10. Once the water has been completely replaced by uranyl acetate, the pump is switched off and the valve 24 is closed. The uranyl acetate remains in the chamber for about 30 minutes.
3. Flushing: The chamber 10 is turned by 180°, the valve 20 is opened and the uranyl acetate in the chamber 10 is replaced by water (cf. FIG. 2). This involves switching the valves 42 and 44, so that the liquid is drained away via the hose 50. This operation is repeated a number of times. At the end, the chamber 10 is turned back again by 180°.
4. Contrasting with lead citrate: The valve 26 is opened and lead citrate is pumped from the container 34 into the chamber 10. Once the water has been completely replaced by lead citrate, the pump 38 is switched off and the valve 26 is closed. The lead citrate remains in the chamber 10 for about 20 minutes.
5. Flushing: The chamber 10 is turned by 180°, the valve 20 is opened and the lead citrate in the chamber 10 is replaced by water (cf. FIG. 2). This involves switching the valve 42, so that the liquid is drained away via the hose 48. This operation is repeated a number of times. At the end, the chamber 10 is turned back again by 180°.
6. Emptying the chamber 10: The chamber 10 is turned by 180° (cf. FIG. 2). The hose 18 is decoupled from the inlet opening 12. The pump 38 is switched on and pumps the water that is in the chamber 10 away through the hose 46. The hose 18 is connected again to the inlet opening 12.
   In the case of an alternative configuration of the invention, the emptying of the chamber 10 takes place by means of an additional valve, which makes it possible for air to be supplied into the chamber 10 through the inlet opening 12. In this case it is possible to dispense with decoupling and subsequent renewed connection of the hose 18 to the inlet opening 12, which facilitates the handling of the device according to the invention.
7. Cleaning: For this purpose, the valve 22 is opened and HNO₃ is pumped from the container 30 through the chamber 10, the pump 38 and the outlet hoses 36, 40. After about two minutes, the valve 22 is closed again and the valve 20 is opened, so that water is pumped in the same way through the system and flushes out the HNO₃.

The method is preferably controlled by a computer program. The program sequence is monitored by a computer (not represented in FIG. 1), which controls the pump 38, the valves 20, 22, 24, 26, 42 and 44 and the motor for rotating the chamber 10 by means of a relay module.

It has been found that a reduction of the contrasting solutions used by over 40% and a reduction of the volume of waste by over 60% can be achieved in comparison with the prior art by the method according to the invention and the device according to the invention. Furthermore, the device according to the invention allows the use of individually prepared solutions (as traditionally used in the case of manual contrasting operations), which can consequently be made to suit the corresponding areas of use in situ.

In the exemplary embodiment represented in FIG. 1, the axis 16 is arranged in the center of the chamber 10, symmetrically at a distance from the inlet opening 12 and the outlet opening 14. In a variant of the invention that is not represented, the axis is arranged closer to the inlet opening 12 than to the outlet opening 14. This has the advantage during a rotation of the chamber 10 that the hose 18 of the supply line system rotating with it only has to complete a smaller movement. This allows the hose 18 to have a shorter length than in the case of a central arrangement of the axis 16, which results in a lower volume to flow through on the supply line side.

In this variant, however, the hose 36 must be made somewhat longer on the removal line side, since it has to complete a greater movement than in the case of a central arrangement of the axis 16 when there is a corresponding rotation of the chamber 10. However, the advantages of volume saving in the case of the hose 16 on the supply line side clearly outweigh possible disadvantages of an increased volume in the case of the hose 36 on the removal line side.

FIG. 2 shows a schematic representation of the first exemplary embodiment of the invention in which the chamber 10 is arranged in the first position, and not as in FIG. 1 in the second position. In this first position, the inlet opening 12 is arranged above the outlet opening 14, so that liquids that have a lower density than the liquid in the chamber 10 can be filled into the chamber 10 or into its hollow space 100.

The representation shown in FIG. 2 merely illustrates a second operating state of the first exemplary embodiment that differs from the first operating state, shown in FIG. 1, by a different position of the chamber 10. Otherwise, the devices of FIGS. 1 and 2 do not differ from each other, so that you are referred to the above explanations relating to FIG. 1.

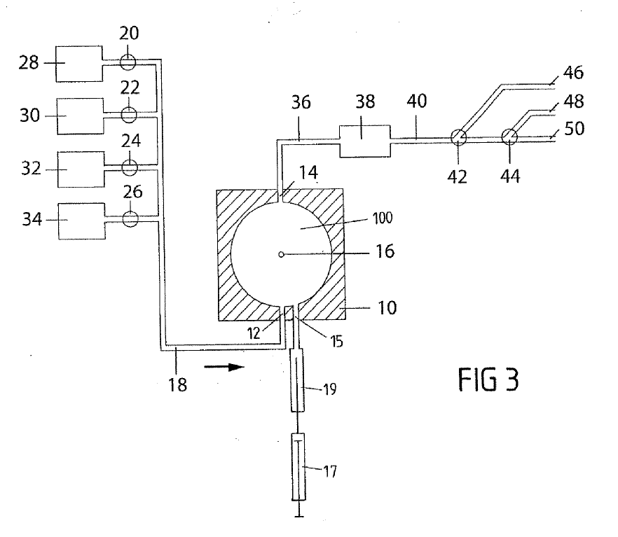

FIG. 3 shows a schematic representation of a second exemplary embodiment of the invention, unchanged elements of the device being provided with the same reference numerals as in FIGS. 1 and 2; with respect to a corresponding explanation, you are referred to the above statements relating to FIGS. 1 and 2. As a difference from the first exemplary embodiment, the chamber 10 has a second inlet opening 15 as a third opening, which is arranged adjacent the inlet opening 12, lying substantially perpendicularly opposite the outlet opening 14. In flow connection with the second inlet opening 15 is an adapter 19, which serves for receiving a syringe 17. By means of the syringe 17, small amounts of liquid can be introduced into the chamber 10 or its hollow space 100 in addition to the liquid supplied via the hose 18. This additional liquid may be the same liquid as in the chamber 10 or a different liquid than the liquid already present in the chamber 10.

With an appropriate configuration of the second inlet opening 15, it is also possible to dispense with the arrangement of an adapter.

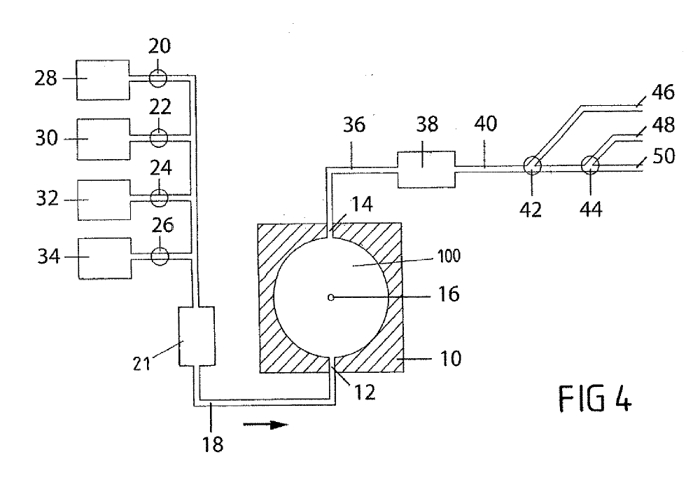

FIG. 4 shows a schematic representation of a third exemplary embodiment of the invention, unchanged elements of the device being provided with the same reference numerals as in FIGS. 1 and 2; with respect to a corresponding explanation, you are referred to the above statements relating to FIGS. 1 and 2.

In the case of this exemplary embodiment, a mixer 21 is additionally provided in the hose 18, that is to say in the supplying hose system, as a mixing device between the containers 28, 30, 32, 34 and the chamber 10. Liquids from the containers 28, 30, 32, 34 are consequently first directed into the mixer 21, mixed there and subsequently supplied to the chamber 10 or its hollow space.

The different elements of the various exemplary embodiments can be combined with one another in any way desired. It is also clearly evident to a person skilled in the art that the device according to the invention and the method according to the invention are suitable not only for the treatment of grids used in electron microscopy but for the treatment of numerous different samples. The liquids that are respectively to be used then differ correspondingly. The number of liquid reservoirs or containers provided can be adapted accordingly. While in the case of the exemplary embodiments explained here in more detail four containers 28, 30, 32, 34 are respectively used for different liquids, it is accordingly possible for a greater or smaller number of containers or liquid reservoirs to be provided. The number of valves to be provided is then to be adapted correspondingly.

A further exemplary embodiment of the invention that is not explicitly represented in a figure is a device for preparing biological samples by means of a series of different liquids containing preparation agents and comprising: (a) a chamber (10) with a first and a second opening (12, 14), and (b) a means (38) for supplying and removing liquid to and from the chamber (10), wherein (c) the device has at least one pump and/or at least one valve which has a hollow body of a flexible material that is resistant to the media used, the liquids flowing through the pump and/or the valve coming into contact exclusively with this hollow body.

1-16. (canceled)

17. A method for preparing biological samples by means of a series of different liquids containing preparation agents in a chamber with a first and a second opening for supplying and removing liquid to and from the chamber, wherein
(a) the chamber is brought into a first position, in which the first opening is located above the second opening when the liquid to be introduced into the chamber has a lower density than the liquid in the chamber,
(b) the chamber is brought into a second position, in which the first opening is located below the second opening when the liquid to be introduced into the chamber has a higher density than the liquid in the chamber.

18. The method of claim 17, wherein the first opening is at the highest point of the chamber in the first position and/or the second opening is at the lowest point of the chamber in the first position.

19. The method of claim 17, wherein the first opening is at the lowest point of the chamber in the second position and/or the second opening is at the highest point of the chamber in the second position.

20. The method of claim 17, wherein the first opening is located vertically above the second opening in the first position of the chamber and/or the second opening is located vertically above the first opening in the second position of the chamber.

21. The method of claim 17, wherein the flow of the liquids through the chamber always takes place from the first opening to the second opening.

22. The method of claim 17, wherein the movement of the chamber from the first position to the second position and from the second position to the first position takes place by a rotation of the chamber by in each case 180°.

23. The method of claim 17, wherein the moving of the chamber takes place by means of an electric motor.

24. A device for preparing biological samples by means of a series of different liquids containing preparation agents and comprising:
(a) a chamber with a first and a second opening, and
(b) a means for supplying and removing liquid to and from the chamber,
wherein
(c) the chamber is rotatably mounted and
(d) the device has a rotating device for rotating the chamber optionally into a first position and into a second position, wherein
(e) in the first position of the chamber the first opening is located above the second opening, and
(f) in the second position of the chamber the first opening is located below the second opening.

25. The device of claim 24, wherein
(a) the first opening is formed exclusively as an inlet opening, and
(b) the second opening is formed exclusively as an outlet opening, wherein
(c) the flow of the liquids through the chamber always takes place from the first opening to the second opening.

26. The device of claim 24, wherein the rotating device has an electric motor.

27. The device of claim 24, wherein the device has at least one pump and/or at least one valve which has a hollow body of a flexible material that is resistant to the media used, the liquids flowing through the pump and/or the valve coming into contact exclusively with this hollow body.

28. The device of claim 24, wherein the first opening is connected to a supply line system which has at least one liquid reservoir and at least one valve.

29. The device of claim 24, wherein the device has a third opening, which is arranged adjacent the first opening.

30. The device of claim 29, wherein the third opening is connected to a supply line system which has at least one liquid reservoir and at least one valve.

31. The device of claim 29, wherein the third opening is formed for receiving a manually operable filling device.

32. The device of claim 28, wherein the supply line system has a mixing device, which is provided and set up for the purpose of receiving and mixing different liquids to be supplied to the chamber in a predeterminable mixing ratio.
